(19) United States
(12) Patent Application Publication
(10) Pub. No.: US 2004/0004359 A1
(43) Pub. Date: Jan. 8, 2004

(54) Door latch mechanism

(76) Inventor: George Wartian, Mt. Clemons, MI (US)

Correspondence Address: REISING, ETHINGTON, BARNES, KISSELLE, P.C., P O BOX 4390, TROY, MI, 48099-4390, US

(21) Appl. No.: 10/188,657

(22) Filed: Jul. 2, 2002

(51) Int. Cl. E05B 3/00

(52) U.S. Cl. 292/336.3

(57) ABSTRACT

A door latch mechanism includes a latch mounted in a housing on the door for movement from a retracted position to an extended latching position. A lever is pivoted to the housing. The lever moves the latch to the retracted position when the lever is pivoted to a working position. The lever may be pivoted to its working position by an actuator on one side of the door and also by an actuator on the opposite side of the door.

### BACKGROUND AND SUMMARY OF THE INVENTION

A door latch usually can be operated from either side of the door. Typically, separate mechanisms are provided. What is needed is a simplified and unified mechanism with a minimum number of parts.

In accordance with the present invention, the latch is mounted on a housing for movement from a retracted position within the housing to an extended latching position projecting outwardly from the housing. A spring presses the latch to the extended latching position. A latch operating assembly is provided for moving the latch to the retracted position against the pressure of the spring. The latch operating assembly includes a lever pivoted inside of the housing. A connection is provided between the lever and the latch operable to move the latch to the retracted position upon pivotal movement of the lever to a working position. A first actuator operable by an operator on one side of the door can be used to pivot the lever to the working position, and a second actuator operable by an operator on the other side of the door can also be used to pivot the lever to the working position.

Preferably, each of the actuators is operable independently of the other and is operable without interference with the other.

In the preferred embodiment, one of the actuators is rotatably mounted on the housing and has a finger engageable with the lever to move it to the working position. The second actuator is pivotally mounted on the housing and also has a finger engageable with the lever for the same purpose.

The connection between the latch and the lever preferably comprises a rod projecting inwardly from the latch through an opening in an arm of the lever, and a head on the inner end of the rod abutting the inner side of the arm.

One object of this invention is to provide a door latch mechanism having the foregoing features and capabilities.

Another object is to provide a door latch mechanism which is composed of a few simple parts, is rugged and durable in use, and is relatively inexpensive to manufacture and assemble.

These and other objects, features and advantages of the invention will become more apparent as the following description proceeds, especially when considered with the accompanying drawings.

### BRIEF DESCRIPTION OF THE DRAWINGS

FIG. 1 is a fragmentary perspective view of a door having latch operating mechanism constructed in accordance with the invention.

FIG. 2 is an edge view of the structure shown in FIG. 1.

FIG. 3 is an enlarged sectional view taken on the line 3-3 in FIG. 1, showing the position of the parts when the latch is extended.

FIG. 4 is a view of a portion of FIG. 3 showing the latch retracted by an operator on one side of the door.

FIG. 5 is a view similar to FIG. 4 showing the latch retracted by an operator on the other side of the door.

FIG. 6 is a view of a portion of FIG. 2 on an enlarged scale, with parts broken away and in section.

### DETAILED DESCRIPTION OF THE PREFERRED EMBODIMENT

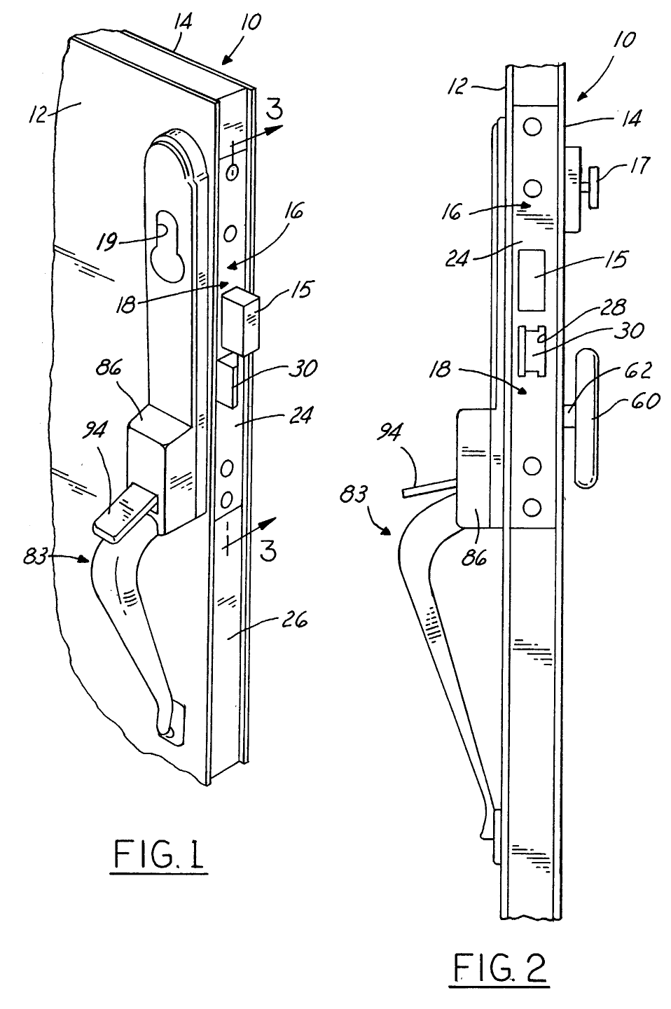

Referring now more particularly to the drawings, and especially FIGS. 1 and 2, there is shown a swinging edge portion of a door 10 having opposite side facing panels 12 and 14, and latch mechanism 16 for releasably latching the door in a closed position relative to a door opening (not shown). A lock bolt 15, which forms no part of this invention, may be extended to a locking position or retracted inside the door by an operator (not shown) controlled by a knob 17 on the inner side of the door or a key inserted in a key-hole 19 on the outer side of the door.

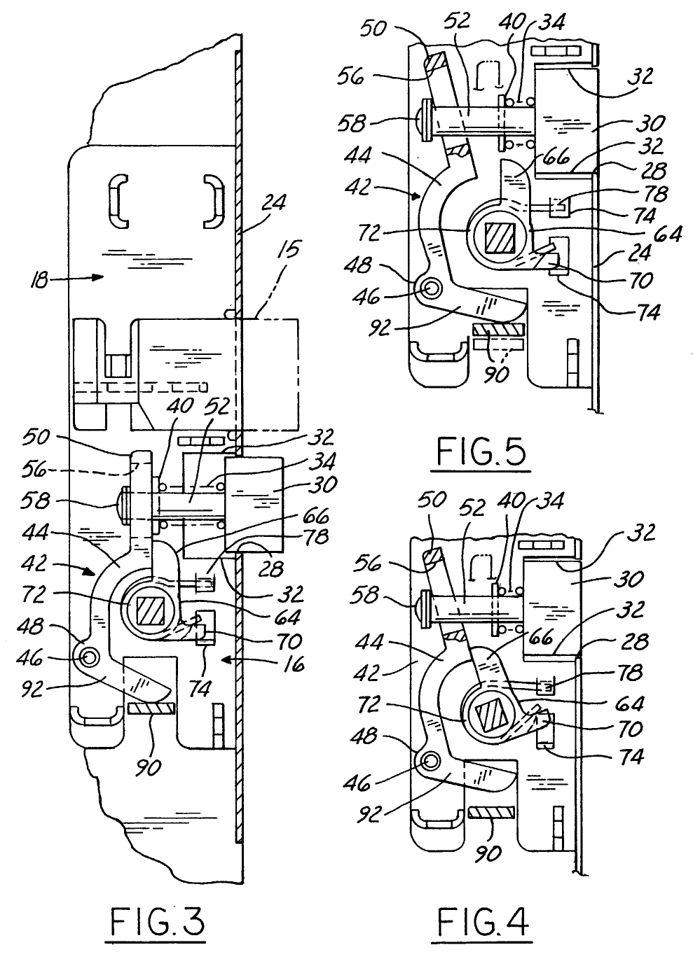

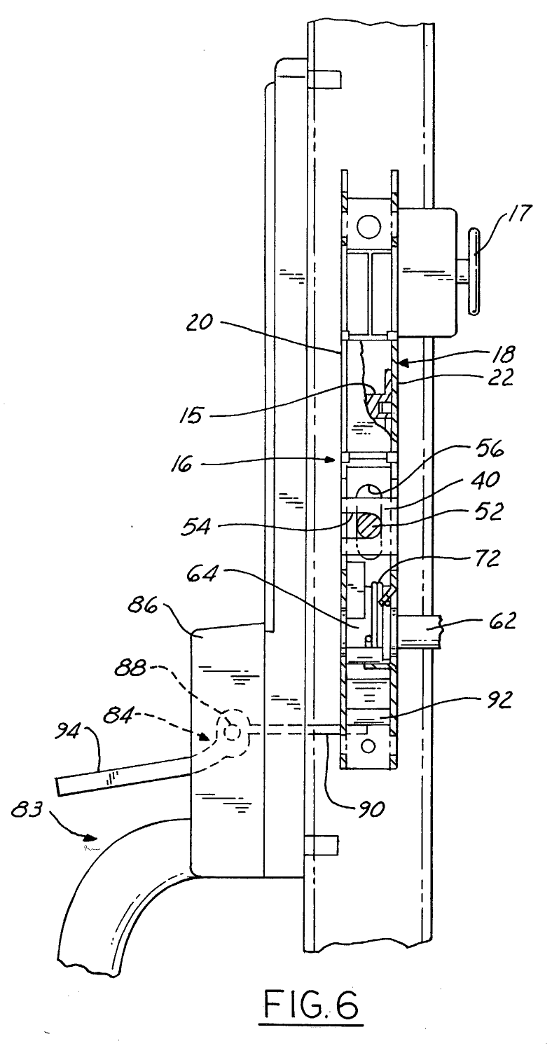

The latch mechanism includes a housing 18 secured within the door between panels 12 and 14 by any suitable means, as by fasteners and/or a suitable adhesive. The housing has parallel side plates 20 and 22 and a front plate 24 which is substantially flush with the front, or swinging, edge 26 of the door. The front plate 24 has a slot 28 just large enough to accommodate a latch 30 which fits in the slot and can slide horizontally outwardly from the retracted unlatching position within the housing shown in FIGS. 4 and 5 to the extended latching position projecting outwardly from the housing shown of FIG. 3. The side plates 20 and 22 have recesses 32 providing edges to assist in guiding the horizontal sliding movement of the latch 30. A coil spring 34 is compressed between the latch and a fixed transverse housing plate 40 to press the latch to its extended latching position.

A latch operating assembly 42 is provided for moving the latch 30 inwardly to its retracted position against the pressure of the spring 34. The latch operating assembly 42 includes a lever 44 within the housing pivoted to the side plates 20 and 22 of the housing by a horizontal transverse pivot 46 extending through an intermediate portion 48 of the lever. The lever has an arm 50 extending from the pivot 46 across the inner end of the latch 30, with the transverse housing plate 40 between the arm 50 and the latch. A horizontal rod 52 secured at one end to the latch 30, extends inwardly from the latch and slides through a hole 54 in the transverse housing plate 40 and through a vertically elongated opening 56 in the arm 50. A head 58 on the opposite end of the rod 52 abuts the inner side of the arm 50.

A knob 60 on the inner side of the door is attached to a square, horizontal, transverse shaft 62 that extends through a hole in the door panel 14 and into a square hole in an actuator 64 that is mounted for rotation in the housing 18, so that the knob 60 can be used to rotate the actuator 64. The actuator 64 has a finger 66 engageable with the arm 50 of the lever 44 but is normally urged clockwise in FIGS. 3-5 by a coil spring 72 to a position in which a prong 70 of the actuator bears against a housing stop 74. The spring 72 has one end affixed to an anchor 78 on the housing 18.

A handle 83 secured on the outer side of the door has an actuator 84. The actuator 84 is mounted inside a cover 86 on a horizontal, transverse pivot 88. Inside the door on one side of the pivot 88 the actuator 84 has a finger 90. The lever 44 has an arm 92 which is disposed directly above the finger 90. The actuator 84 has a hand-operated portion 94 on the opposite side of the pivot 88 which can be pressed down by a thumb of a person to operate the actuator 84 from the outer side of the door.

FIG. 3 shows the normal position of the parts in which the latch 30 is pressed by the spring 34 to the extended position projecting outside the housing 18 to engage a suitable keeper (not shown) to hold the door closed. The extended latch causes the head 58 of the rod 52 to draw the lever arm 50 up against the transverse housing plate 40.

To retract the latch 30 by means of the knob 60 on the inner side of the door, the knob is rotated to rotate the actuator 64 to the position of FIG. 4, causing the actuator finger 66 to engage the arm 50 of the lever and pivot the arm away from the transverse housing plate 40, thereby pulling the latch 30 against the pressure of the spring to the retracted position shown in FIG. 4.

To retract the latch 30 by means of the actuator 84 on the outer side of the door, the hand-operated portion 94 of the actuator 84 is depressed, to raise the finger 90 from the broken line position in FIG. 5 to the solid line position, in turn to raise the arm 92 of the lever 30, thus pivoting the lever away from the transverse housing plate 40 and pulling the latch to the retracted position shown in FIG. 5.

What is claimed is:

1. A door latch mechanism comprising:
a housing,
a latch,
means mounting said latch on said housing for movement from a retracted position within said housing to an extended latching position projecting outwardly from said housing,
a spring pressing said latch to said extended position, and
a latch operating assembly for moving said latch to said retracted position against the pressure of said spring comprising a lever in said housing,
a pivot connecting said lever to said housing for pivotal movement,
a connection between, said lever and said latch operable to move said latch to the retracted position thereof upon pivotal movement of said lever to a working position,
a first actuator operable by a first operator on one side of the housing for pivoting said lever to said working position, and
a second actuator operable by a second operator on another side of the housing for pivoting said lever to said working position.

2. The door latch mechanism of claim 1, wherein each of the actuators is operable independently of, and without interference with, the other of the actuators.

3. The door latch mechanism of claim 1, wherein said first actuator is rotatably mounted on said housing and has a first finger engageable with said lever, and said second actuator is pivotally mounted on said housing and has a second finger engageable with said lever.

4. The door latch mechanism comprising,
a housing,
a latch,
means mounting said latch on said housing for movement from a retracted position within the housing to an extended latching position projecting outwardly from said housing,
a spring pressing said latch to said extended position, and a latch operating assembly for moving said latch to said retracted position against the pressure of said spring comprising a lever in said housing,
a pivot connecting an intermediate portion of said lever for pivotal movement,
said lever having a first arm extending from said pivot across an inner end of said latch,
said lever having a second arm extending from said pivot,
a connection between the first arm of said lever and said latch operable to move said latch to the retracted position thereof upon pivotal movement of said lever to a working position,
a first actuator operable by a first operator on one side of the housing for engaging said first arm of said lever to pivot said lever to said working position, and
a second actuator operable by a second operator on another side of the housing for engaging said second arm of said lever to pivot said lever to said working position.

5. The door latch mechanism of claim 4, wherein said first actuator is rotatably mounted on said housing and has a first finger engageable with said first arm, and said second actuator is pivotally mounted on said housing and has a second finger engageable with said second arm.

6. The door latch mechanism of claim 5, wherein said connection comprises a rod projecting inwardly from said latch and sliding through an opening in said first arm of said lever, and a head on the inner end of said rod abutting the inner side of said first arm.
